(19) United States
(12) Patent Application Publication
(10) Pub. No.: US 2024/0357497 A1
(43) Pub. Date: Oct. 24, 2024

(54) MOBILITY WITH LOW-POWER WAKE-UP SIGNAL

(71) Applicant: Nokia Technologies Oy, Espoo (FI)

(72) Inventors: Jussi-Pekka KOSKINEN, Oulu (FI); Jorma Johannes KAIKKONEN, Oulu (FI); Lars DALSGAARD, Oulu (FI); Samuli Heikki TURTINEN, Ii (FI)

(21) Appl. No.: 18/644,223

(22) Filed: Apr. 24, 2024

Related U.S. Application Data
(60) Provisional application No. 63/461,508, filed on Apr. 24, 2023.

(51) Int. Cl. H04W 52/02; H04W 24/10; H04W 68/02; H04W 76/28

(52) U.S. Cl. CPC H04W 52/0235; H04W 24/10; H04W 68/02; H04W 76/28

(57) ABSTRACT

Systems, methods, apparatuses, and computer program products for monitoring LP-WUS quality for determining how to perform cell reselection evaluation. One method may include a user equipment measuring at least one quality of at least one low-power wake-up signal received by a wake-up receiver of the user equipment, and performing cell reselection evaluation based upon the at least one quality.

### TECHNICAL FIELD

Some example embodiments may generally relate to mobile or wireless telecommunication systems, such as 3^{rd} Generation Partnership Project (3GPP) Long Term Evolution (LTE), 5^{th} generation (5G) radio access technology (RAT), new radio (NR) access technology, 6^{th} generation (6G), and/or other communications systems. For example, certain example embodiments may relate to systems and/or methods for a user equipment (UE) monitoring low-power (LP)-wake-up signal (WUS) quality/strength for determining how to perform cell reselection evaluation.

### BACKGROUND

Examples of mobile or wireless telecommunication systems may include radio frequency (RF) 5G RAT, the Universal Mobile Telecommunications System (UMTS) Terrestrial Radio Access Network (UTRAN), LTE Evolved UTRAN (E-UTRAN), LTE-Advanced (LTE-A), LTE-A Pro, NR access technology, and/or MulteFire Alliance. 5G wireless systems refer to the next generation (NG) of radio systems and network architecture. A 5G system is typically built on a 5G NR, but a 5G (or NG) network may also be built on E-UTRA radio. It is expected that NR can support service categories such as enhanced mobile broadband (eMBB), ultra-reliable low-latency-communication (URLLC), and massive machine-type communication (mMTC). NR is expected to deliver extreme broadband, ultra-robust, low-latency connectivity, and massive networking to support the Internet of Things (IoT). The next generation radio access network (NG-RAN) represents the radio access network (RAN) for 5G, which may provide radio access for NR, LTE, and LTE-A. It is noted that the nodes in 5G providing radio access functionality to a UE (e.g., similar to the Node B in UTRAN or the Evolved Node B (eNB) in LTE) may be referred to as next-generation Node B (gNB) when built on NR radio, and may be referred to as next-generation eNB (NG-eNB) when built on E-UTRA radio.

### SUMMARY

In accordance with some example embodiments, a method may include measuring, by a user equipment, at least one quality of at least one low-power wake-up signal. The method may further include performing, by the user equipment, cell reselection evaluation based upon the at least one quality.

In accordance with certain example embodiments, an apparatus may include means for measuring at least one quality of at least one low-power wake-up signal. The apparatus may further include means for performing cell reselection evaluation based upon the at least one quality.

In accordance with various example embodiments, a non-transitory computer readable medium may include program instructions that, when executed by an apparatus, cause the apparatus to perform at least a method. The method may include measuring at least one quality of at least one low-power wake-up signal. The method may further include performing cell reselection evaluation based upon the at least one quality.

In accordance with some example embodiments, a computer program product may perform a method. The method may include measuring at least one quality of at least one low-power wake-up signal. The method may further include performing cell reselection evaluation based upon the at least one quality.

In accordance with certain example embodiments, an apparatus may include at least one processor and at least one memory storing instructions that, when executed by the at least one processor, cause the apparatus at least to measure at least one quality of at least one low-power wake-up signal. The at least one memory and instructions, when executed by the at least one processor, may further cause the apparatus at least to perform cell reselection evaluation based upon the at least one quality.

In accordance with various example embodiments, an apparatus may include measuring circuitry configured to measure at least one quality of at least one low-power wake-up signal. The apparatus may further include evaluating circuitry configured to perform cell reselection evaluation based upon the at least one quality.

In accordance with some example embodiments, a method may include transmitting, by a network entity, to a user equipment at least one low-power wake-up signal configured for measurements associated with performing cell reselection evaluation.

In accordance with certain example embodiments, an apparatus may include means for transmitting to a user equipment at least one low-power wake-up signal configured for measurements associated with performing cell reselection evaluation.

In accordance with various example embodiments, a non-transitory computer readable medium may include program instructions that, when executed by an apparatus, cause the apparatus to perform at least a method. The method may include transmitting to a user equipment at least one low-power wake-up signal configured for measurements associated with performing cell reselection evaluation.

In accordance with some example embodiments, a computer program product may perform a method. The method may include transmitting to a user equipment at least one low-power wake-up signal configured for measurements associated with performing cell reselection evaluation.

In accordance with certain example embodiments, an apparatus may include at least one processor and at least one memory storing instructions that, when executed by the at least one processor, cause the apparatus at least to transmit to a user equipment at least one low-power wake-up signal configured for measurements associated with performing cell reselection evaluation.

In accordance with various example embodiments, an apparatus may include transmitting circuitry configured to transmit to a user equipment at least one low-power wake-up signal configured for measurements associated with performing cell reselection evaluation.

### BRIEF DESCRIPTION OF THE DRAWINGS

For a proper understanding of example embodiments, reference should be made to the accompanying drawings, wherein:

FIG. 1 illustrates an example of UE operations with LP-WUS receivers;

FIG. 2 illustrates an example of a signaling diagram according to certain example embodiments;

FIG. 3 illustrates an example of a flow diagram of a method that may be performed by a UE according to various example embodiments;

FIG. 4 illustrates an example of a flow diagram of a method that may be performed by a network entity according to certain example embodiments;

FIG. 5 illustrates an example of various network devices according to some example embodiments; and

FIG. 6 illustrates an example of a 5G network and system architecture according to certain example embodiments.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for monitoring LP-WUS quality/strength for determining how to perform cell reselection evaluation is not intended to limit the scope of certain example embodiments, but is instead representative of selected example embodiments.

3GPP is studying using a LP-WUS receiver at a UE, and how that may reduce power consumption by the UE. For example, a main receiver of the UE may be in a sleep mode (or even powered off) or in a deep sleep mode to conserve power, and may be activated only upon receiving a WUS from the network. The network may trigger the UE to wake up exactly when needed in an event-driven manner by transmitting a WUS to the UE, which may be monitored by a dedicated LP-WUS receiver at the UE. When the UE receives the WUS, the WUS receiver may wake up the main radio or the ordinary NR transceiver and begin communication.

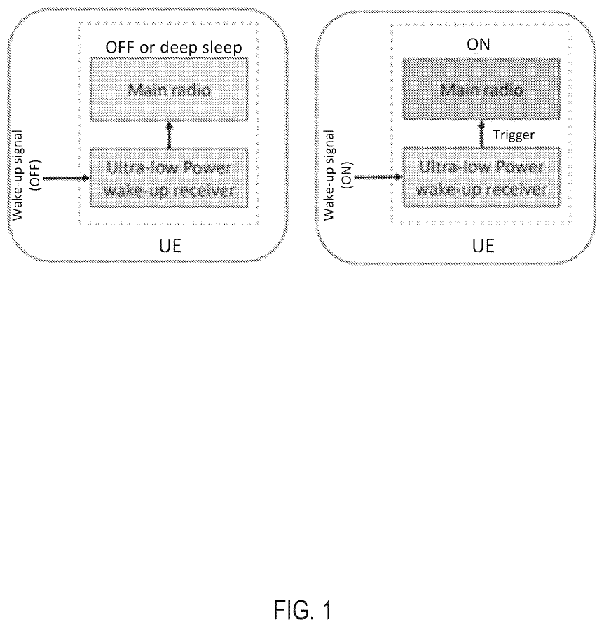

As illustrated in FIG. 1, an ultra-LP receiver may wake up the main receiver, which may otherwise remain OFF and/or kept in a deep sleep mode. The LP wake-up receiver may always be in ON operation while consuming very little power. While in ON operation, the UE may consume significantly less power compared to the NR transceiver by using a simple signal (e.g., WUS) and dedicated hardware for its monitoring, which may only be configured to receive the WUS. The LP-WUS may be used for both UE IDLE/INACTIVE and CONNECTED mode. Development continues on downlink (DL) reception where LP-WUS may wake up the main receiver to receive physical downlink control channel (PDCCH)/physical downlink shared channel (PDSCH).

Certain example embodiments described herein may have various benefits and/or advantages to overcome the disadvantages described above. For example, certain example embodiments may reduce power consumption by the UE. For example, configuring eDRX for “normal” paging monitoring may not be possible because that may increase latency for paging reception (i.e., for mobile terminated data transmission). Thus, lower latency (e.g., <10 s) may need to be paired with a matching paging configuration. The main radio of the UE may remain in sleep modes for longer periods while the LP-WUR monitors the quality of the LP-WUS, which may save battery power. If LP-WUS quality falls below a threshold, the main radio may perform radio resource management (RRM) measurements more frequently. When LP-WUS quality worsens, the UE may move outside the coverage area of the NR cell and perform cell re-selection. If the main radio is not performing regular measurements at a cell edge, re-selection may be missed. The next time the main radio wakes up, it may need to begin searching the cell because the cell became out of range while the UE was in sleep mode. Thus, certain example embodiments discussed below are directed to improvements in computer-related technology.

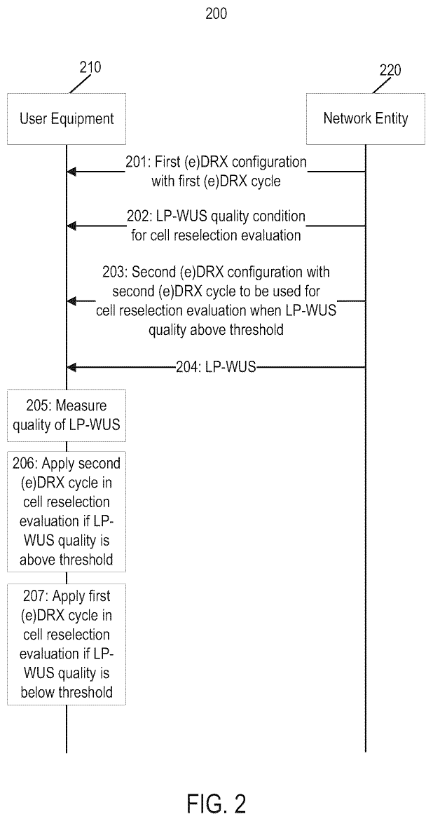

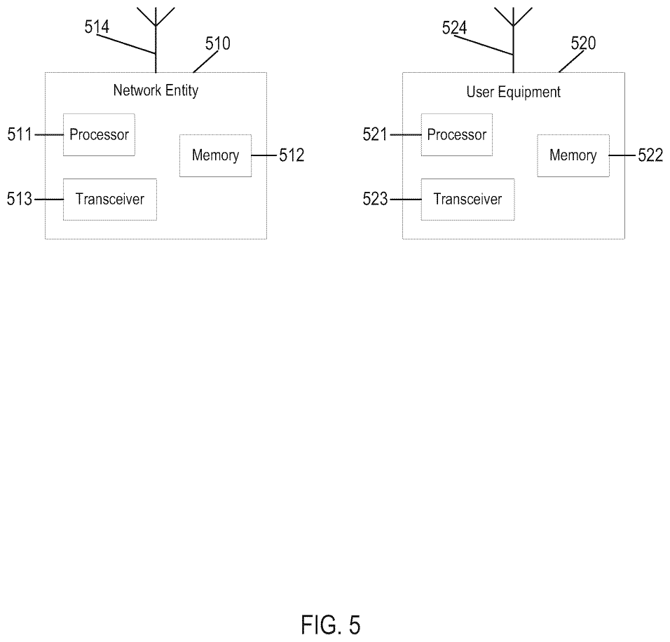

FIG. 2 illustrates an example of a signaling diagram 200 for monitoring LP-WUS quality for determining how to perform cell reselection evaluation. NE 220 and UE 210 may be similar to NE 510 and UE 520, as illustrated in FIG. 5, according to certain example embodiments.

At operation 201, NE 220 may transmit to UE 210 a first (e)DRX configuration including (e)DRX cycle.

The first (e)DRX configuration including (e)DRX cycle may include at least one of serving cell measurements requirements, intra-frequency cell reselection requirements, inter-frequency cell reselection requirements, and inter-RAT reselection requirements.

At operation 202, NE 220 may transmit to UE 210 a LP-WUS quality condition for cell reselection evaluation.

At operation 203, NE 220 may transmit to UE 210 a second (e)DRX configuration with (e)DRX cycle to be used for cell reselection evaluation when the quality of a LP-WUS is above a threshold. In some example embodiments, a default (e)DRX may be used, and may negate the need to provide a second (e)DRX configuration with (e)DRX cycle. The default (e)DRX may be statically specified.

The at least one second (e)DRX configuration may not be configured for paging monitoring, but instead for UE 210 to determine RRM measurement requirements.

In certain example embodiments, the at least one second (e)DRX configuration may include at least one (e)DRX cycle related configuration (e.g., T_{eDRX, CN}, T_{eDRX, RAN}, eDRX_IDLE cycle, ran-ExtendedPagingCycle, and/or corresponding parameters).

In some example embodiments, the at least one second (e)DRX configuration may include at least one paging time window (PTW) duration configuration and/or related parameter, such as N_{serv_RedCap} and/or scaling factor N1 (e.g., derived from the (e)DRX configuration for measurement requirements).

In various example embodiments, the at least one second (e)DRX configuration may include a RAN (e)DRX configuration (i.e., ran-ExtendedPagingCycle) in RRCRelease (e.g., from suspendConfig for RRC_IDLE mode).

In certain example embodiments, the at least one second (e)DRX configuration may indicate that (e)DRX is not allowed in RRCRelease, which may indicate that the second (e)DRX configuration is for LP-WUS RRM requirements.

In various example embodiments, UE 210 may be configured with at least one (e)DRX configuration for following cell reselection evaluation requirements (e.g., 3GPP TS 38.133, clause 4.2B.2 2). UE 210 may use the at least one second (e)DRX configuration received at operation 203 for cell reselection evaluation, or the at least one (e)DRX configuration.

In some example embodiments, the at least one second (e)DRX configuration may indicate that (e)DRX may not be allowed when UE 210 is operating in LP-WUS mode. The indication could be provided in RRCRelease or in a system information broadcast (SIB).

In various example embodiments, the at least one second (e)DRX configuration may indicate which RRC states of the LP-WUS signal quality threshold above may be applicable.

At operation 204, NE 220 may transmit at least one consecutive LP-WUS to a wake-up receiver of UE 210 during a certain time period. The number of consecutive LP-WUS signals may be network-controlled and/or determined by specification.

In some example embodiments, NE 220 may transmit to UE 210 LP-WUS and/or LP-WUS reference signals (e.g., WUS beacon) constantly in LP-WUS/LP-WUS beacon transmission occasions. For example, UE 210 may measure a quality of these LP-WUS/LP-WUS signals. In other examples, NE 220 may configure UE 210 with a quality threshold for these LP-WUS/LP-WUS signals.

In some example embodiments, the at least one consecutive LP-WUS may include sequences used to generate an ON symbol by an orthogonal frequency-division multiplexing (OFDM) transmitter. The transmitter may use a maximum amplitude of the resource element (RE) (except a dual connectivity (DC) carrier in the middle) in order to maximize energy in the multi carrier on-off keying (MC-OOK) ON symbol. When transmitting an OFF symbol, the sequences may be 0, thereby minimizing the energy of the MC-OOK OFF symbol. Each transmitted bit “0” or “1” may be translated into a sequence of alternating “ON” and “OFF” symbols, where the subcarriers in the ON symbols may have high energy (e.g., all sub carriers except DC may have maximum amplitude), and the subcarriers in the OFF symbols may all be 0.

Various example embodiments may include a simplified OOK receiver, which may also work with MC-OOK signals. A bandpass filter may remove signals outside the frequency range covered by the subcarriers in the MC-OOK signal, the low-noise amplifier (LNA) may amplify the signal before it is fed into an envelope detector. After the envelope detector, the signal may be a low frequency signal, being either low when a “0” is received, or high when a “1” is received. By integrating the signal over each symbol duration, signal noise may be suppressed, and a comparator may determine if the received symbol is a “0” or “1” by comparing with the average signal level. The received bit stream may be fed to a correlator, which may correlate the detected bit sequence with an expected LP-WUS message.

At operation 205, UE 210 may measure at least one quality of at least one of the consecutive LP-WUSs received at operation 204, and perform cell reselection evaluation based upon the at least one quality of at least one measured LP-WUS. As an example, the at least one quality may include any combination of strength, power, received signal strength indicator (RSSI), signal to interference and noise ratio (SINR), reference signal received power (RSRP), or reference signal received quality (RSRQ).

In various example embodiments, in response to a determination that a variation of a strength of the at least one consecutive wake-up signal is below a predetermined threshold, UE 210 may apply at least one radio resource management measurement requirement according to the at least one extended discontinuous reception configuration. In some example embodiments, in response to a determination that the apparatus is operating in a low-power wake-up signal mode, and is not configured with an extended discontinuous reception cycle for a current radio resource control state or any radio resource control state, UE 210 may apply a default extended discontinuous reception cycle length for radio resource management measurement requirements.

At operation 206, UE 210 may perform cell reselection evaluation by determining that the at least one quality of at least one LP-WUS measured at operation 205 is above at least one predetermined threshold, and apply the second (e)DRX cycle in cell reselection evaluation received at operation 203.

UE 210 may stop performing measurements at operation 205 if the WUS signal (e.g., based on one or more samples) is above a given threshold. For example, measurements may be serving cell measurements, intra-frequency measurements and/or any other measurements (inter-frequency and/or inter-RAT measurements).

At operation 207, UE 210 may perform cell reselection evaluation by determining that the at least one quality of at least one LP-WUS measured at operation 205 is at or below the at least one predetermined threshold, and apply the first (e)DRX cycle in cell reselection evaluation.

In certain example embodiments, UE 210 may not be configured with (e)DRX, but may use an (e)DRX cycle indicated in the received at least one (e)DRX configuration in the RRM measurements when LP-WUS signal quality/strength is above a threshold.

In some example embodiments, UE 210 may follow (e)DRX-based RRM measurement requirements when the signal strength of the WUS is constant (i.e., no variation in the measurement results or variation is small enough (i.e., less than +/−dB)).

In various example embodiments, UE 210 may use a default (e)DRX cycle length to perform RRM requirements while in LP-WUS mode. UE 210 may not be configured with (e)DRX cycle for the current RRC state and/or if UE 210 is not configured with (e)DRX cycle for any RRC state. The default (e)DRX cycle may be defined in specifications.

In some example embodiments, the LP-WUS signal quality/strength threshold may apply in any of IDLE, INACTIVE, and/or CONNECTED RRC states.

At operation 207, UE 210 may apply the first (e)DRX configuration, and follow legacy RRM measurement requirements when the at least one quality of at least one LP-WUS measured at 205 is equal to or below the at least one predetermined threshold. UE 210 may perform RRM measurements once per (e)DRX cycle (e.g., less than 1 second). For example, UE 210 may be configured with (e)DRX to follow cell reselection evaluation requirements (e.g., 3GPP TS 38.133, clause 4.2.2).

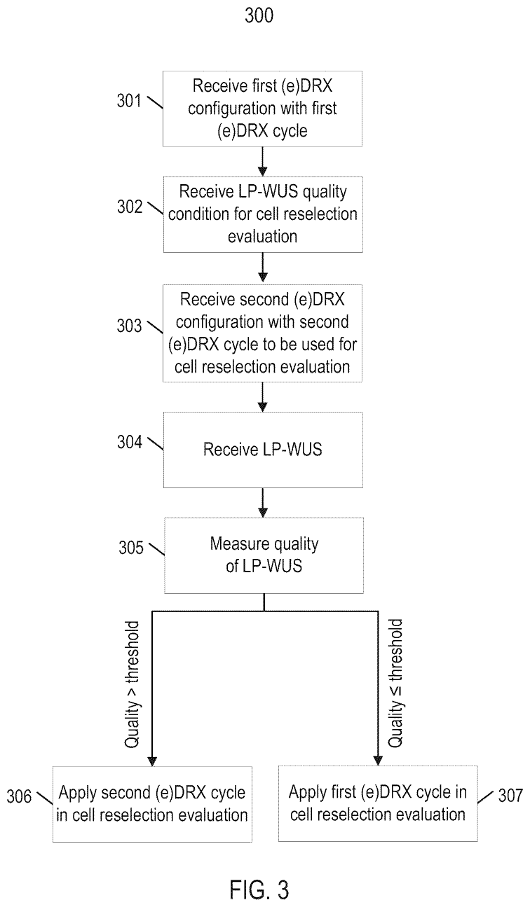

FIG. 3 illustrates an example of a flow diagram of a method 300 for monitoring LP-WUS quality for determining how to perform cell reselection evaluation that may be performed by a UE, such as UE 520 illustrated in FIG. 5, according to various example embodiments.

At step 301, the method may include receiving a first (e)DRX configuration including (e)DRX cycle from a NE, such as NE 510 illustrated in FIG. 5.

The first (e)DRX configuration including (e)DRX cycle may include at least one of serving cell measurements requirements, intra-frequency cell reselection requirements, inter-frequency cell reselection requirements, and inter-RAT reselection requirements.

At step 302, the method may include receiving a LP-WUS quality condition from the NE for cell reselection evaluation.

At step 303, the method may include receiving a second (e)DRX configuration with (e)DRX cycle from the NE to be used for cell reselection evaluation when the quality of a LP-WUS is above a threshold. In some example embodiments, a default (e)DRX may be used, and may negate the need to provide a second (e)DRX configuration with (e)DRX cycle. The default (e)DRX may be statically specified.

The at least one second (e)DRX configuration may not be configured for paging monitoring, but instead for the UE to determine RRM measurement requirements.

In certain example embodiments, the at least one second (e)DRX configuration may include at least one (e)DRX cycle related configuration (e.g., T_{eDRX, CN}, T_{eDRX, RAN}, eDRX_IDLE cycle, ran-ExtendedPagingCycle, and/or corresponding parameters).

In some example embodiments, the at least one second (e)DRX configuration may include at least one PTW duration configuration and/or related parameter, such as N_{serv_RedCap} and/or scaling factor N1 (e.g., derived from the (e)DRX configuration for measurement requirements).

In various example embodiments, the at least one second (e)DRX configuration may include a RAN (e)DRX configuration (i.e., ran-ExtendedPagingCycle) in RRCRelease (e.g., from suspendConfig for RRC_IDLE mode).

In certain example embodiments, the at least one second (e)DRX configuration may indicate that (e)DRX is not allowed in RRCRelease, which may indicate that the second (e)DRX configuration is for LP-WUS RRM requirements.

In various example embodiments, the UE may be configured with at least one (e)DRX configuration for following cell reselection evaluation requirements (e.g., 3GPP TS 38.133, clause 4.2B.2 2). The UE may use the at least one second (e)DRX configuration received at operation 303 for cell reselection evaluation, or the at least one (e)DRX configuration.

In some example embodiments, the at least one second (e)DRX configuration may indicate that (e)DRX may not be allowed when the UE is operating in LP-WUS mode. The indication could be provided in RRCRelease or in a SIB.

In various example embodiments, the at least one second (e)DRX configuration may indicate which RRC states of the LP-WUS signal quality threshold above may be applicable.

At step 304, the method may further include receiving at least one consecutive LP-WUS from the NE by a wake-up receiver of the UE during a certain time period. The number of WUS signals may be network-controlled and/or determined by specification.

In some example embodiments, the NE may transmit to the UE LP-WUS and/or LP-WUS reference signals (e.g., WUS beacon) constantly in LP-WUS/LP-WUS beacon transmission occasions. For example, the UE may measure a quality of these LP-WUS/LP-WUS signals. In other examples, the NE may configure the UE with a quality threshold for these LP-WUS/LP-WUS signals.

In some example embodiments, the at least one consecutive LP-WUS may include sequences used to generate an ON symbol by an OFDM transmitter. The transmitter may use a maximum amplitude of the RE (except a DC carrier in the middle) in order to maximize energy in the MC-OOK ON symbol. When transmitting an OFF symbol, the sequences may be 0, thereby minimizing the energy of the MC-OOK OFF symbol. Each transmitted bit “0” or “1” may be translated into a sequence of alternating “ON” and “OFF” symbols, where the subcarriers in the ON symbols may have high energy (e.g., all sub carriers except DC may have maximum amplitude), and the subcarriers in the OFF symbols may all be 0.

Various example embodiments may include a simplified OOK receiver, which may also work with MC-OOK signals. A bandpass filter may remove signals outside the frequency range covered by the subcarriers in the MC-OOK signal, the LNA may amplify the signal before it is fed into an envelope detector. After the envelope detector, the signal may be a low frequency signal, being either low when a “0” is received, or high when a “1” is received. By integrating the signal over each symbol duration, signal noise may be suppressed, and a comparator may determine if the received symbol is a “0” or “1” by comparing with the average signal level. The received bit stream may be fed to a correlator, which may correlate the detected bit sequence with an expected LP-WUS message.

At step 305, the method may include measuring at least one quality of at least one of the consecutive LP-WUSs received at step 304. As an example, the at least one quality may include any combination of strength, power, RSSI, SINR, RSRP, or RSRQ.

In various example embodiments, in response to a determination that a variation of a strength of the at least one consecutive wake-up signal is below a predetermined threshold, UE 210 may apply at least one radio resource management measurement requirement according to the at least one extended discontinuous reception configuration. In some example embodiments, in response to a determination that the apparatus is operating in a low-power wake-up signal mode, and is not configured with an extended discontinuous reception cycle for a current radio resource control state or any radio resource control state, UE 210 may apply a default extended discontinuous reception cycle length for radio resource management measurement requirements.

At step 306, the method may include performing cell reselection evaluation by determining that the at least one quality of at least one LP-WUS measured at operation 305 is above at least one predetermined threshold, and applying the second (e)DRX configuration in cell reselection evaluation.

The UE may stop performing measurements at operation 305 if the WUS signal (e.g., based on one or more samples) is above a given threshold. For example, measurements may be serving cell measurements, intra-frequency measurements and/or any other measurements (inter-frequency and/or inter-RAT measurements).

At step 307, the method may include performing cell reselection evaluation by determining that the at least one quality of at least one LP-WUS measured at operation 305 is at or below the at least one predetermined threshold, and applying the first (e)DRX cycle in cell reselection evaluation.

In certain example embodiments, the UE may not be configured with (e)DRX, but may use an (e)DRX cycle indicated in the received at least one (e)DRX configuration in the RRM measurements when LP-WUS signal quality/strength is above a threshold.

In some example embodiments, the UE may follow (e)DRX-based RRM measurement requirements when the signal strength of the WUS is constant (i.e., no variation in the measurement results or variation is small enough (i.e., less than +/−dB)).

In various example embodiments, the UE may use a default (e)DRX cycle length to perform RRM requirements while in LP-WUS mode. The UE may not be configured with (e)DRX cycle for the current RRC state and/or if the UE is not configured with (e)DRX cycle for any RRC state. The default (e)DRX cycle may be defined in specifications.

In some example embodiments, the LP-WUS signal quality/strength threshold may apply in any of IDLE, INACTIVE, and/or CONNECTED RRC states.

At step 307, the method may include applying the first (e)DRX configuration and follow legacy RRM measurement requirements when the at least one quality of at least one LP-WUS measured at 305 is equal to or below the at least one predetermined threshold. The UE may perform RRM measurements once per (e)DRX cycle (e.g., less than 1 second). For example, the UE may be configured with (e)DRX to follow cell reselection evaluation requirements (e.g., 3GPP TS 38.133, clause 4.2.2).

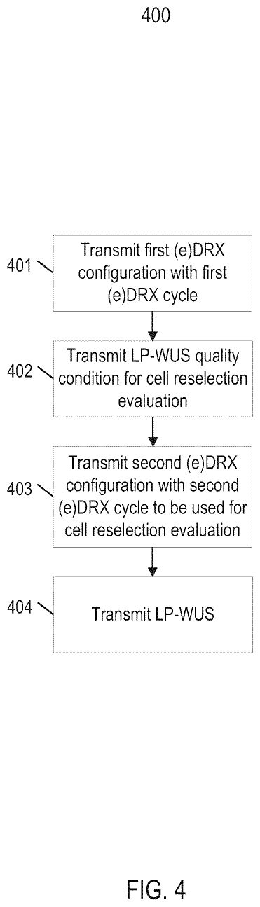

FIG. 4 illustrates an example of a flow diagram of a method 400 for monitoring LP-WUS quality for determining how to perform cell reselection evaluation that may be performed by a NE, such as NE 510 illustrated in FIG. 5, according to various example embodiments.

At step 401, the method may include transmitting a first (e)DRX configuration including (e)DRX cycle to a UE, such as UE 520 illustrated in FIG. 5.

The first (e)DRX configuration including (e)DRX cycle may include at least one of serving cell measurements requirements, intra-frequency cell reselection requirements, inter-frequency cell reselection requirements, and inter-RAT reselection requirements.

At step 402, the method may include transmitting a LP-WUS quality condition for cell reselection evaluation to the UE.

At step 403, the method may include transmitting a second (e)DRX configuration with (e)DRX cycle to be used for cell reselection evaluation when the quality of a LP-WUS is above a threshold. In some example embodiments, a default (e)DRX may be used, and may negate the need to provide a second (e)DRX configuration with (e)DRX cycle. The default (e)DRX may be statically specified.

The at least one second (e)DRX configuration may not be configured for paging monitoring, but instead for the UE to determine RRM measurement requirements.

In certain example embodiments, the at least one second (e)DRX configuration may include at least one (e)DRX cycle related configuration (e.g., T_{eDRX, CN}, T_{eDRX, RAN}, eDRX_IDLE cycle, ran-ExtendedPagingCycle, and/or corresponding parameters).

In some example embodiments, the at least one second (e)DRX configuration may include at least one PTW duration configuration and/or related parameter, such as N_{serv_RedCap} and/or scaling factor N1 (e.g., derived from the (e)DRX configuration for measurement requirements).

In various example embodiments, the at least one second (e)DRX configuration may include a RAN (e)DRX configuration (i.e., ran-ExtendedPagingCycle) in RRCRelease (e.g., from suspendConfig for RRC_IDLE mode).

In certain example embodiments, the at least one second (e)DRX configuration may indicate that (e)DRX is not allowed in RRCRelease, which may indicate that the second (e)DRX configuration is for LP-WUS RRM requirements.

In various example embodiments, the NE may configure the UE with at least one (e)DRX configuration for following cell reselection evaluation requirements (e.g., 3GPP TS 38.133, clause 4.2B.2 2). The UE may use the at least one second (e)DRX configuration transmitted at operation 403 for cell reselection evaluation, or the at least one (e)DRX configuration.

In some example embodiments, the at least one second (e)DRX configuration may indicate that (e)DRX may not be allowed when the UE is operating in LP-WUS mode. The indication could be provided in RRCRelease or in a system information broadcast (SIB).

In various example embodiments, the at least one second (e)DRX configuration may indicate which RRC states of the LP-WUS signal quality threshold above may be applicable.

At step 404, the method may further include transmitting at least one consecutive LP-WUS by a wake-up receiver of the UE during a certain time period. The number of WUS signals may be network-controlled and/or determined by specification.

In some example embodiments, the UE may receive from the NE LP-WUS and/or LP-WUS reference signals (e.g., WUS beacon) constantly in LP-WUS/LP-WUS beacon transmission occasions. For example, the UE may measure a quality of these LP-WUS/LP-WUS signals. In other examples, the UE may be configured by the NE with a quality threshold for these LP-WUS/LP-WUS signals.

In some example embodiments, the at least one consecutive LP-WUS may include sequences used to generate an ON symbol by an OFDM transmitter. The transmitter may use a maximum amplitude of the RE (except a DC carrier in the middle) in order to maximize energy in the MC-OOK ON symbol. When transmitting an OFF symbol, the sequences may be 0, thereby minimizing the energy of the MC-OOK OFF symbol. Each transmitted bit “0” or “1” may be translated into a sequence of alternating “ON” and “OFF” symbols, where the subcarriers in the ON symbols may have high energy (e.g., all sub carriers except DC may have maximum amplitude), and the subcarriers in the OFF symbols may all be 0.

Various example embodiments may include a simplified OOK receiver, which may also work with MC-OOK signals. A bandpass filter may remove signals outside the frequency range covered by the subcarriers in the MC-OOK signal, the LNA may amplify the signal before it is fed into an envelope detector. After the envelope detector, the signal may be a low frequency signal, being either low when a “0” is received, or high when a “1” is received. By integrating the signal over each symbol duration, signal noise may be suppressed, and a comparator may determine if the received symbol is a “0” or “1” by comparing with the average signal level. The received bit stream may be fed to a correlator, which may correlate the detected bit sequence with an expected LP-WUS message.

FIG. 5 illustrates an example of a system according to certain example embodiments. In one example embodiment, a system may include multiple devices, such as, for example, NE 510 and/or UE 520.

NE 510 may be one or more of a base station (e.g., 3G UMTS NodeB, 4G LTE Evolved NodeB, or 5G NR Next Generation NodeB), a serving gateway, a server, and/or any other access node or combination thereof.

NE 510 may further include at least one gNB-centralized unit (CU), which may be associated with at least one gNB-distributed unit (DU). The at least one gNB-CU and the at least one gNB-DU may be in communication via at least one F1 interface, at least one Xₙ-C interface, and/or at least one NG interface via a 5^{th} generation core (5GC).

UE 520 may include one or more of a mobile device, such as a mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, or any combination thereof. Furthermore, NE 510 and/or UE 520 may be one or more of a citizens broadband radio service device (CBSD).

NE 510 and/or UE 520 may include at least one processor, respectively indicated as 511 and 521. Processors 511 and 521 may be embodied by any computational or data processing device, such as a central processing unit (CPU), application specific integrated circuit (ASIC), or comparable device. The processors may be implemented as a single controller, or a plurality of controllers or processors.

At least one memory may be provided in one or more of the devices, as indicated at 512 and 522. The memory may be fixed or removable. The memory may include computer program instructions or computer code contained therein. Memories 512 and 522 may independently be any suitable storage device, such as a non-transitory computer-readable medium. The term “non-transitory,”as used herein, may correspond to a limitation of the medium itself (i.e., tangible, not a signal) as opposed to a limitation on data storage persistency (e.g., random access memory (RAM) vs. read-only memory (ROM)). A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory, and which may be processed by the processors, may be any suitable form of computer program code, for example, a compiled or interpreted computer program written in any suitable programming language.

Processors 511 and 521, memories 512 and 522, and any subset thereof, may be configured to provide means corresponding to the various blocks of FIGS. 2-4. Although not shown, the devices may also include positioning hardware, such as GPS or micro electrical mechanical system (MEMS) hardware, which may be used to determine a location of the device. Other sensors are also permitted, and may be configured to determine location, elevation, velocity, orientation, and so forth, such as barometers, compasses, and the like.

As shown in FIG. 5, transceivers 513 and 523 may be provided, and one or more devices may also include at least one antenna, respectively illustrated as 514 and 524. The device may have many antennas, such as an array of antennas configured for multiple input multiple output (MIMO) communications, or multiple antennas for multiple RATs. Other configurations of these devices, for example, may be provided. Transceivers 513 and 523 may be a transmitter, a receiver, both a transmitter and a receiver, or a unit or device that may be configured both for transmission and reception. Transceiver 523 may also include a wake-up receiver for LP-WUS reception and LP-WUS quality monitoring. The wake-up receiver may be the same or different from a main receiver, which may be used for transmission/reception of NR signals.

The memory and the computer program instructions may be configured, with the processor for the particular device, to cause a hardware apparatus, such as UE, to perform any of the processes described above (i.e., FIGS. 2-4). Therefore, in certain example embodiments, a non-transitory computer-readable medium may be encoded with computer instructions that, when executed in hardware, perform a process such as one of the processes described herein. Alternatively, certain example embodiments may be performed entirely in hardware.

In certain example embodiments, an apparatus may include circuitry configured to perform any of the processes or functions illustrated in FIGS. 2-4. As used in this application, the term “circuitry” may refer to one or more or all of the following: (a) hardware-only circuit implementations (such as implementations in only analog and/or digital circuitry), (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions), and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

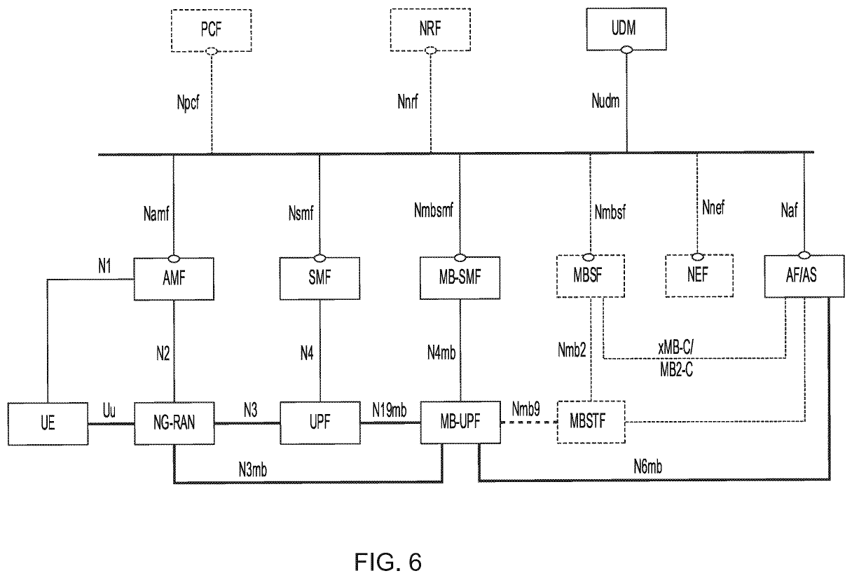

FIG. 6 illustrates an example of a 5G network and system architecture according to certain example embodiments. Shown are multiple network functions that may be implemented as software operating as part of a network device or dedicated hardware, as a network device itself or dedicated hardware, or as a virtual function operating as a network device or dedicated hardware. The NE and UE illustrated in FIG. 6 may be similar to NE 510 and UE 520, respectively. The user plane function (UPF) may provide services such as intra-RAT and inter-RAT mobility, routing and forwarding of data packets, inspection of packets, user plane quality of service (QoS) processing, buffering of downlink packets, and/or triggering of downlink data notifications. The application function (AF) may primarily interface with the core network to facilitate application usage of traffic routing and interact with the policy framework.

According to certain example embodiments, processors 511 and 521, and memories 512 and 522, may be included in or may form a part of processing circuitry or control circuitry. In addition, in some example embodiments, transceivers 513 and 523 may be included in or may form a part of transceiving circuitry.

In some example embodiments, an apparatus (e.g., NE 510 and/or UE 520) may include means for performing a method, a process, or any of the variants discussed herein. Examples of the means may include one or more processors, memory, controllers, transmitters, receivers, and/or computer program code for causing the performance of the operations.

In various example embodiments, apparatus 520 may be controlled by memory 522 and processor 521 to measure at least one quality of at least one low-power wake-up signal, and perform cell reselection evaluation based upon the at least one quality.

Certain example embodiments may be directed to an apparatus that includes means for performing any of the methods described herein including, for example, means for measuring at least one quality of at least one low-power wake-up signal, and means for performing cell reselection evaluation based upon the at least one quality.

In various example embodiments, apparatus 510 may be controlled by memory 512 and processor 511 to transmit to a user equipment at least one low-power wake-up signal configured for measurements associated with performing cell reselection evaluation.

Certain example embodiments may be directed to an apparatus that includes means for performing any of the methods described herein including, for example, means for transmitting to a user equipment at least one low-power wake-up signal configured for measurements associated with performing cell reselection evaluation.

In various example embodiments, apparatus 520 may be controlled by memory 522 and processor 521 to measure at least one quality of at least one low-power wake-up signal received by a wake-up receiver of the apparatus, and perform cell reselection evaluation based upon the quality of at least one low-power wake-up signal received by a wake-up receiver of the apparatus.

Certain example embodiments may be directed to an apparatus that includes means for performing any of the methods described herein including, for example, means for measuring at least one quality of at least one low-power wake-up signal received by a wake-up receiver of the apparatus, and means for performing cell reselection evaluation based upon the quality of at least one low-power wake-up signal received by a wake-up receiver of the apparatus.

In various example embodiments, apparatus 510 may be controlled by memory 512 and processor 511 to transmit to a user equipment at least one consecutive wake-up signal.

Certain example embodiments may be directed to an apparatus that includes means for performing any of the methods described herein including, for example, means for transmitting to a user equipment at least one consecutive wake-up signal.

The features, structures, or characteristics of example embodiments described throughout this specification may be combined in any suitable manner in one or more example embodiments. For example, the usage of the phrases “various embodiments,” “certain embodiments,” “some embodiments,” or other similar language throughout this specification refers to the fact that a particular feature, structure, or characteristic described in connection with an example embodiment may be included in at least one example embodiment. Thus, appearances of the phrases “in various embodiments,” “in certain embodiments,” “in some embodiments,” or other similar language throughout this specification does not necessarily all refer to the same group of example embodiments, and the described features, structures, or characteristics may be combined in any suitable manner in one or more example embodiments.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

Additionally, if desired, the different functions or procedures discussed above may be performed in a different order and/or concurrently with each other. Furthermore, if desired, one or more of the described functions or procedures may be optional or may be combined. As such, the description above should be considered as illustrative of the principles and teachings of certain example embodiments, and not in limitation thereof.

One having ordinary skill in the art will readily understand that the example embodiments discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of the example embodiments.

### Partial Glossary

3GPP 3^{rd} Generation Partnership Project
5G 5^{th} Generation
5GC 5^{th} Generation Core
6G 6^{th} Generation
AF Application Function
ASIC Application Specific Integrated Circuit
CBSD Citizens Broadband Radio Service Device
CPU Central Processing Unit
CU Centralized Unit
dB Decibel
DC Dual Connectivity
DL Downlink
DU Distributed Unit
eDRX Extended Discontinuous Reception
eMBB Enhanced Mobile Broadband
eNB Evolved Node B
gNB Next Generation Node B
GPS Global Positioning System
HDD Hard Disk Drive
IoT Internet of Things
LNA Low-Noise Amplifier
LP Low-Power
LTE Long-Term Evolution
LTE-A Long-Term Evolution Advanced
MC-OOK Multicarrier On-Off Keying
MEMS Micro Electrical Mechanical System
MIMO Multiple Input Multiple Output
mMTC Massive Machine Type Communication
NE Network Entity
NG Next Generation
NG-eNB Next Generation Evolved Node B
NG-RAN Next Generation Radio Access Network
NR New Radio
OFDM Orthogonal Frequency-Division Multiplexing
PDA Personal Digital Assistance
PDCCH Physical Downlink Control Channel
PDSCH Physical Downlink Shared Channel
PTW Paging Time Window
QoS Quality of Service
RAM Random Access Memory
RAN Radio Access Network
RAT Radio Access Technology
RE Resource Element
RF Radio Frequency
ROM Read-Only Memory
RRC Radio Resource Control
RRM Radio Resource Management
RS Reference Signal
RSRP Reference Signal Received Power
RSRQ Reference Signal Received Quality
RSSI Received Signal Strength Indicator
SIB System Information Broadcast
SINR Signal to Interference & Noise Ratio
SMF Session Management Function
UE User Equipment
UMTS Universal Mobile Telecommunications System
UPF User Plane Function
URLLC Ultra-Reliable and Low-Latency Communication
UTRAN Universal Mobile Telecommunications System Terrestrial Radio Access Network
WUS Wake-Up Signal

1.-96. (canceled)

97. An apparatus comprising:
a processor; and
a non-transitory computer-readable medium comprising computer-executable instructions that, when executed by the processor, cause the processor to perform the following operations:
apply a first measurement of qualities of at least one low-power wake-up signal, wherein the qualities comprise strength, power, signal to interference and noise ratio, received signal strength indicator, reference signal received power, and reference signal received quality;
in response to the qualities being at or below respective thresholds, apply a plurality of first radio resource management measurement requirements according to a discontinuous reception configuration, wherein the plurality of first radio resource management measurement requirements comprises serving cell measurements requirements, intra-frequency cell reselection requirements, inter-frequency cell reselection requirements, and inter-radio access technology reselection requirements;
receive from a network entity at least one extended discontinuous reception configuration configured to apply at least one second radio resource management measurement requirement, wherein the at least one extended discontinuous reception configuration comprises: at least one radio access network extended discontinuous reception configuration in radio resource control release, at least one extended discontinuous reception cycle related configuration, at least one paging time window duration configuration, at least one radio resource management measurement requirement associated with the qualities being above or below the respective thresholds;
apply a second measurement of the at least one quality of the at least one low-power wake-up signal; and
based on the second measurement and in response to the at least one quality being at or above at least one predetermined threshold:
apply the at least one second radio resource management measurement requirement according to the at least one extended discontinuous reception configuration; and
perform a cell reselection evaluation based upon the at least one quality.

98. The apparatus of claim 97, wherein the at least one low-power wake-up signal is received by a wake-up receiver of the apparatus.

99. The apparatus of claim 98, wherein the at least one second radio resource management measurement requirement is based at least in part on the at least one quality.

100. The apparatus of claim 99, wherein the computer-executable instructions further cause the processor to perform the following operations:
receive at least one indication of radio resource states that apply to the at least one predetermined threshold.

101. The apparatus of claim 100, wherein the computer-executable instructions further cause the processor to perform the following operations:
receive from a network entity at least one consecutive wake-up signal.

102. The apparatus of claim 101, wherein the computer-executable instructions further cause the processor to perform the following operations:
in response to a determination that the apparatus is operating in a low-power wake-up signal mode, and is not configured with an extended discontinuous reception cycle for a current radio resource control state or any radio resource control state, apply a default extended discontinuous reception cycle length for radio resource management measurement requirements.

103. The apparatus of claim 102, wherein the computer-executable instructions further cause the processor to perform the following operations:
receive the at least one consecutive wake-up signal above at least one predetermined threshold.

104. The apparatus of claim 103, wherein the at least one consecutive wake-up signal is network-controlled or specification-defined.

105. A system comprising:
an apparatus comprising:
a processor; and
a non-transitory computer-readable medium comprising computer-executable instructions that, when executed by the processor, cause the processor to perform the following operations:
apply a first measurement of qualities of at least one low-power wake-up signal, wherein the qualities comprise strength, power, signal to interference and noise ratio, received signal strength indicator, reference signal received power, and reference signal received quality;
in response to the qualities being at or below respective thresholds, apply a plurality of first radio resource management measurement requirements according to a discontinuous reception configuration, wherein the plurality of first radio resource management measurement requirements comprises serving cell measurements requirements, intra-frequency cell reselection requirements, inter-frequency cell reselection requirements, and inter-radio access technology reselection requirements;
receive from a network entity at least one extended discontinuous reception configuration configured to apply at least one second radio resource management measurement requirement, wherein the at least one extended discontinuous reception configuration comprises: at least one radio access network extended discontinuous reception configuration in radio resource control release, at least one extended discontinuous reception cycle related configuration, at least one paging time window duration configuration, at least one radio resource management measurement requirement associated with the qualities being above or below the respective thresholds;
apply a second measurement of the at least one quality of the at least one low-power wake-up signal; and
based on the second measurement and in response to the at least one quality being at or above at least one predetermined threshold:
apply the at least one second radio resource management measurement requirement according to the at least one extended discontinuous reception configuration; and
perform a cell reselection evaluation based upon the at least one quality.

106. The system of claim 105, wherein the at least one low-power wake-up signal is received by a wake-up receiver of the apparatus.

107. The system of claim 106, wherein the at least one second radio resource management measurement requirement is based at least in part on the at least one quality.

108. The system of claim 107, wherein the computer-executable instructions further cause the processor to perform the following operations:
receive at least one indication of radio resource states that apply to the at least one predetermined threshold.

109. The system of claim 108, wherein the computer-executable instructions further cause the processor to perform the following operations:
receive from a network entity at least one consecutive wake-up signal.

110. The system of claim 109, wherein the computer-executable instructions further cause the processor to perform the following operations:
in response to a determination that the apparatus is operating in a low-power wake-up signal mode, and is not configured with an extended discontinuous reception cycle for a current radio resource control state or any radio resource control state, apply a default extended discontinuous reception cycle length for radio resource management measurement requirements.

111. The system of claim 110, wherein the computer-executable instructions further cause the processor to perform the following operations:
receive the at least one consecutive wake-up signal above at least one predetermined threshold.

112. The system of claim 111, wherein the at least one consecutive wake-up signal is network-controlled or specification-defined.

113. A method comprising:
applying a first measurement of qualities of at least one low-power wake-up signal, wherein the qualities comprise strength, power, signal to interference and noise ratio, received signal strength indicator, reference signal received power, and reference signal received quality;
in response to the qualities being at or below respective thresholds, applying a plurality of first radio resource management measurement requirements according to a discontinuous reception configuration, wherein the plurality of first radio resource management measurement requirements comprises serving cell measurements requirements, intra-frequency cell reselection requirements, inter-frequency cell reselection requirements, and inter-radio access technology reselection requirements;
receiving from a network entity at least one extended discontinuous reception configuration configured to apply at least one second radio resource management measurement requirement, wherein the at least one extended discontinuous reception configuration comprises:
at least one radio access network extended discontinuous reception configuration in radio resource control release, at least one extended discontinuous reception cycle related configuration, at least one paging time window duration configuration, at least one radio resource management measurement requirement associated with the qualities being above or below the respective thresholds;
applying a second measurement of the at least one quality of the at least one low-power wake-up signal; and
based on the second measurement and in response to the at least one quality being at or above at least one predetermined threshold:
applying the at least one second radio resource management measurement requirement according to the at least one extended discontinuous reception configuration; and
performing a cell reselection evaluation based upon the at least one quality.

114. The system of claim 113, wherein the at least one low-power wake-up signal is received by a wake-up receiver of the apparatus.

115. The system of claim 114, wherein the at least one second radio resource management measurement requirement is based at least in part on the at least one quality.

116. The system of claim 115, further comprising
in response to a determination that the apparatus is operating in a low-power wake-up signal mode, and is not configured with an extended discontinuous reception cycle for a current radio resource control state or any radio resource control state, applying a default extended discontinuous reception cycle length for radio resource management measurement requirements.
